(19) United States
(12) Patent Application Publication
(10) Pub. No.: US 2020/0150860 A1
(43) Pub. Date: May 14, 2020

(54) MOBILE TERMINAL AND CONTROL METHOD THEREFOR, AND READABLE STORAGE MEDIUM

(71) Applicant: HuiZhou TCL Mobile Communication Co., Ltd., HuiZhou (CN)

(72) Inventor: Qi YU, HuiZhou (CN)

(73) Assignee: HuiZhou TCL Mobile Communication Co., Ltd., HuiZhou (CN)

(21) Appl. No.: 16/630,868

(22) PCT Filed: Jul. 13, 2018
(86) PCT No.: PCT/CN2018/095661

§ 371 Date: Jan. 14, 2020

(30) Foreign Application Priority Data
Jul. 14, 2017 (CN) 201710576283.8

(51) Int. Cl. G06F 3/0488; G06F 3/0482; G06F 1/16

(52) U.S. Cl. CPC G06F 3/04883; G06F 2200/1612; G06F 1/1637; G06F 3/0482

(57) ABSTRACT

Disclosed in the present invention are a mobile terminal and a control method therefor, and a readable storage medium. The method comprises: obtaining operation information of a user in an edge touch area of a curved screen of a mobile terminal; detecting a current interface state of the mobile terminal; and controlling the mobile terminal to perform a corresponding operation according to the operation information of the user in the edge touch area of the curved screen of the mobile terminal and the current interface state of the mobile terminal.

This application claims the priority of Chinese Patent Application No. 201710576283.8, entitled “MOBILE TERMINAL AND CONTROL METHOD THEREFOR, AND READABLE STORAGE MEDIUM”, filed on Jul. 14, 2017 in the CNIPA (National Intellectual Property Administration, PRC), the disclosure of which is incorporated herein by reference in its entirety.

### FIELD OF THE INVENTION

The present invention relates to a touch control technique, and more particularly, to a mobile terminal, a control method thereof, and a related machine readable storage medium.

### BACKGROUND OF THE INVENTION

A cell phone with touch panel has become the most popular cell phone. A user could click or slide the display or a functional bottom on the display to control the cell phone. However, the mobile terminal still has physical bottoms. These bottoms increase the non-integrity of the structure of the cell phone and thus make it more difficult to put more protections, such as ESD, waterproof or dustproof, on the cell phone. For example, the gap between the bottoms increases the difficulties to raise the protections. In addition, because the display size becomes larger, the user needs to use both hands to control the cell phone. This decreases the user's operational efficiency and raises the user's operational costs. Therefore, the conventional mobile terminal needs to be improved.

### SUMMARY OF THE INVENTION

One objective of an embodiment of the present invention is to provide a mobile terminal, a control method thereof, and a related machine readable storage medium to reduce the physical bottoms of the mobile terminal. This makes it more convenient for a user to use a single hand to control the mobile terminal. In addition, it also increases the integrity of the structure of the mobile terminal.

According to an embodiment of the present invention, a control method of a mobile terminal is disclosed. The control method comprises: obtaining a user's operation information in a touch area at an edge of a curved display of the mobile terminal; detecting an interface condition of the mobile terminal; and controlling the mobile terminal to perform a corresponding operation according to the interface condition and the user's operation information.

In the control method, the user's operation information comprises a sliding operation and a click operation.

In the control method, the interface condition comprises a main display condition, a photo interface condition and a video playing interface condition.

In the control method, the step of controlling the mobile terminal to perform the corresponding operation according to the interface condition and the user's operation information comprises:

determining whether the user's operation information is a specific operation in a current interface condition; and

controlling the mobile terminal to perform a corresponding operation according to a predetermined function controlling rule if the user's operation is the specific operation in the current interface condition.

In the control method, the specific operation in the current interface condition comprises a sliding operation in the main display condition, a click operation in the photo interface condition, and/or a sliding operation in the video playing interface condition.

In the control method, the step of controlling the mobile terminal to perform the corresponding operation according to the predetermined function controlling rule if the user's operation is the specific operation in the current interface condition comprises:

controlling the mobile terminal to adjust a volume of a ring when determining that the sliding operation is performed at the edge of the curved display of the mobile terminal in the main display condition;

controlling the mobile terminal to take a photo when the click operation is performed at the edge of the curved display of the mobile terminal in the photo interface condition; and

controlling the mobile terminal to adjust a volume of a video when determining that the sliding operation is performed at the edge of the curved display of the mobile terminal in the video playing interface condition.

In the control method, the control method further comprises following steps after the step of determining whether the user's operation information is the specific operation in the current interface condition:

controlling the mobile terminal not to respond when determining that the user's operation information is not the specific operation in the current interface condition.

In the control method, the control method further comprises following steps before the step of obtaining the user's operation information in the touch area at the edge of the curved display of the mobile terminal:

determining whether a touch position is in the touch area at the edge of the curved display; and

if the touch position is in the touch area at the edge of the curved display, then performing the step of obtaining the user's operation information in the touch area at the edge of the curved display of the mobile terminal.

According to an embodiment of the present invention, a mobile terminal is disclosed. The mobile terminal comprises: a touch chip; a storage device, configured to store a control program of the mobile terminal; a processor; and a bus, configured to realize communications between the processor and the storage device; wherein the processor is configured to execute the control program to perform following steps: determining whether a touch position is in a touch area at an edge of a curved display; if the touch position is in the touch area at the edge of the curved display, obtaining a user's operation information in the touch area at the edge of the curved display of the mobile terminal; detecting an interface condition of the mobile terminal; controlling the mobile terminal to perform a corresponding operation according to the interface condition and the user's operation information; and if the touch position is not in the touch area at the edge of the curved display, controlling the mobile terminal to perform a corresponding touch operation.

In the mobile terminal, the operation of controlling the mobile terminal to perform the corresponding operation according to the interface condition and the user's operation information comprises:

determining whether the user's operation information is a specific operation in a current interface condition; and

controlling the mobile terminal to perform a corresponding operation according to a predetermined function controlling rule if the user's operation is the specific operation in the current interface condition.

In the mobile terminal, the operation of controlling the mobile terminal to perform the corresponding operation according to the predetermined function controlling rule if the user's operation is the specific operation in the current interface condition comprises:

controlling the mobile terminal to adjust a volume of a ring when determining that a sliding operation is performed at the edge of the curved display of the mobile terminal in a main display condition.

In the mobile terminal, the operation of controlling the mobile terminal to perform the corresponding operation according to the predetermined function controlling rule if the user's operation is the specific operation in the current interface condition comprises:

controlling the mobile terminal to take a photo when a click operation is performed at the edge of the curved display of the mobile terminal in the photo interface condition.

In the mobile terminal, the operation of controlling the mobile terminal to perform the corresponding operation according to the predetermined function controlling rule if the user's operation is the specific operation in the current interface condition comprises:

controlling the mobile terminal to adjust a volume of a video when determining that a sliding operation is performed at the edge of the curved display of the mobile terminal in the video playing interface condition.

In the mobile terminal, the processor executes the control program to further perform a following operation before the operation of determining whether the user's operation information is the specific operation in the current interface condition:

controlling the mobile terminal not to respond when determining that the user's operation information is not the specific operation in the current interface condition.

According to an embodiment of the present invention, a machine readable storage medium is disclosed. The machine readable storage medium stores one or more program instructions executable by one or more processors to perform operations of:

determining whether a touch position is in a touch area at an edge of a curved display;

if the touch position is in the touch area at the edge of the curved display, obtaining a user's operation information in the touch area at the edge of the curved display of the mobile terminal;

detecting an interface condition of the mobile terminal;

controlling the mobile terminal to perform a corresponding operation according to the interface condition and the user's operation information; and

if the touch position is not in the touch area at the edge of the curved display, controlling the mobile terminal to perform a corresponding touch operation.

In the machine readable storage medium, the operation of controlling the mobile terminal to perform the corresponding operation according to the interface condition and the user's operation information comprises:

determining whether the user's operation information is a specific operation in a current interface condition; and

controlling the mobile terminal to perform a corresponding operation according to a predetermined function controlling rule if the user's operation is the specific operation in the current interface condition.

In the machine readable storage medium, the operation of controlling the mobile terminal to perform the corresponding operation according to the predetermined function controlling rule if the user's operation is the specific operation in the current interface condition comprises:

controlling the mobile terminal to adjust a volume of a ring when determining that a sliding operation is performed at the edge of the curved display of the mobile terminal in a main display condition.

In the machine readable storage medium, the operation of controlling the mobile terminal to perform the corresponding operation according to the predetermined function controlling rule if the user's operation is the specific operation in the current interface condition comprises:

controlling the mobile terminal to take a photo when a click operation is performed at the edge of the curved display of the mobile terminal in the photo interface condition.

In the machine readable storage medium, the operation of controlling the mobile terminal to perform the corresponding operation according to the predetermined function controlling rule if the user's operation is the specific operation in the current interface condition comprises:

controlling the mobile terminal to adjust a volume of a video when determining that a sliding operation is performed at the edge of the curved display of the mobile terminal in the video playing interface condition.

In the machine readable storage medium, after the operation of determining whether the user's operation information is the specific operation in the current interface condition, the one or more program instructions executable by the one or more processors to perform an operation of:

controlling the mobile terminal not to respond when determining that the user's operation information is not the specific operation in the current interface condition.

In contrast to the conventional art, a mobile terminal, a control method thereof, and a related machine readable storage medium are provided. The control method comprises: obtaining a user's operation information in a touch area at an edge of a curved display of the mobile terminal; detecting an interface condition of the mobile terminal; and controlling the mobile terminal to perform a corresponding operation according to the interface condition and the user's operation information. In this way, an embodiment of the present invention makes it more convenient for a user to use a single hand to perform a function of the mobile terminal. This reduces the user's operation costs and raises the user's operation efficiency. In addition, it also increases the integrity of the structure of the mobile terminal and thus increases the protections of the mobile terminal.

### BRIEF DESCRIPTION OF THE DRAWINGS

FIG. 1 is a flow chart of a control method of a mobile terminal according to an embodiment of the present invention.

FIG. 2 is a flow chart of controlling the mobile terminal to perform a corresponding operation according to an embodiment of the present invention.

FIG. 3 is a diagram of a mobile terminal according to an embodiment of the present invention.

FIG. 4 is a diagram of a detailed structure of a mobile terminal according to an embodiment of the present invention.

### DETAILED DESCRIPTION OF PREFERRED EMBODIMENTS

The present invention provides a mobile terminal, a control method, and a related machine readable storage medium. The invention is described below in detail with reference to the accompanying drawings, wherein like reference numerals are used to identify like elements illustrated in one or more of the figures thereof, and in which exemplary embodiments of the invention are shown. This invention may, however, be embodied in many different forms and should not be construed as limited to the particular embodiments set forth herein. Rather, these embodiments are provided so that this disclosure will be thorough and complete, and will fully convey the scope of the invention to those skilled in the art.

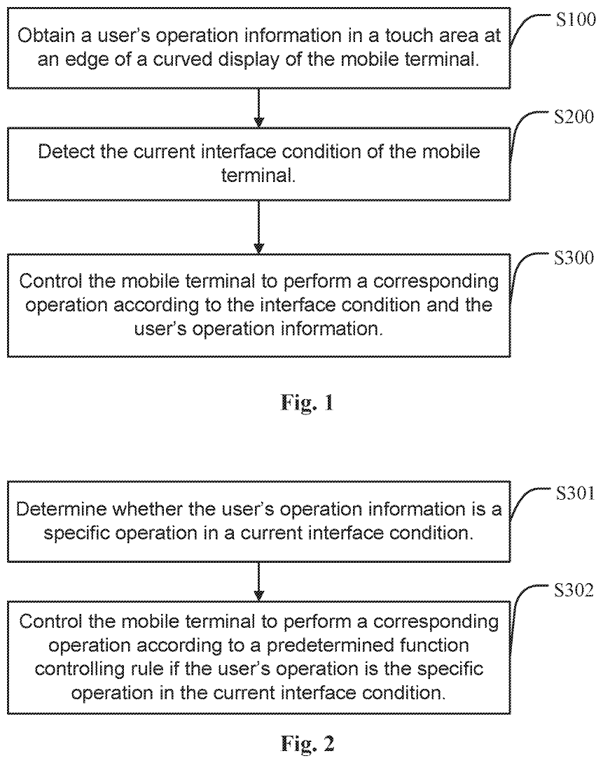

Please refer to FIG. 1. FIG. 1 is a flow chart of a control method of a mobile terminal according to an embodiment of the present invention. The control method comprises the following steps:

S100: Obtain a user's operation information in a touch area at an edge of a curved display of the mobile terminal.

In this embodiment, the mobile terminal has a touch area at an edge of a curved display. The mobile terminal could be a tablet, a cell phone, an MP3 player, an MP4 player or other smart devices. The touch area at the edge of the curved display is an area that a user's finger could naturally reach when the user uses a single hand to hold the mobile terminal. This touch area could be set according to the user's usage demands. In the actual implementation, the touch area could be a right edge or a left edge of the curved display.

The touch area at the edge of the curved display could be realized by virtual bottoms in order to reduce the number of physical bottoms. This improves the integrity of the structure of the mobile terminal, increases the protection of the mobile terminal, and prevents the water and dust from entering into the mobile terminal through the gap between the bottoms.

In a preferred embodiment, the user's operation information comprises a sliding operation (e.g. slide up and down) and a click operation. The user could perform a sliding operation to adjust the volume or could perform a click operation to take a picture through the mobile terminal. In the actual implementation, different operations could be performed in different interface conditions such that the mobile terminal could perform a corresponding function according to the user's operation on the touch area at the edge of the display.

In this embodiment, a touch chip could be installed at the edge of the display of the mobile terminal. When the user touches the touch area at the edge of the curved display of the mobile terminal, the touch chip could detect the user's current operation and send the user's operation information to the CPU to further control the mobile terminal to perform a corresponding operation. This allows the user to control the mobile terminal to perform a corresponding operation without adding more physical bottoms.

S200: Detect the current interface condition of the mobile terminal.

The mobile terminals could be in different interface conditions. In this way, when the user performs an operation on the mobile terminal, the mobile terminal could perform different functions in response. Specifically, the interface conditions of the mobile terminal comprise a main display condition, a photo interface condition, and a video playing interface condition. In the main display condition, the user could perform an operation on the touch area at the edge of the display to adjust the volume of the ring of the mobile terminal. In the photo interface condition, the user could perform an operation on the touch area at the edge of the display to use the mobile terminal to take a photo. In the video playing interface condition, the user could perform an operation on the touch area at the edge of the display to adjust the volume of the video. From the above, it could be seen that the mobile terminal could perform different functions according to the interface condition that the mobile terminal is in. This increase the intelligence of the mobile terminal.

S300: Control the mobile terminal to perform a corresponding operation according to the interface condition and the user's operation information.

Specifically, the user could perform different operations on the touch area at the edge of the curved display. In response, the mobile terminal performs different functions. Furthermore, according to different interface conditions, the mobile terminal could perform different functions as well.

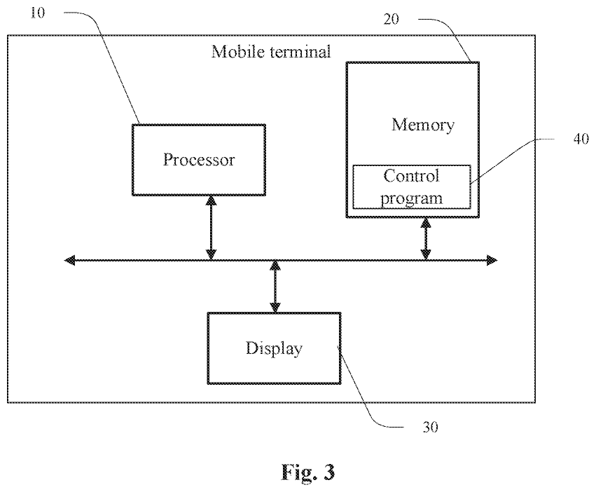

Please refer to FIG. 2. FIG. 2 is a flow chart of controlling the mobile terminal to perform a corresponding operation according to an embodiment of the present invention. The above-mentioned step S300 comprises:

S301: Determine whether the user's operation information is a specific operation in a current interface condition.

S302: Control the mobile terminal to perform a corresponding operation according to a predetermined function controlling rule if the user's operation is the specific operation in the current interface condition.

In this embodiment, the specific operation in the current interface condition comprises the sliding operation in the main display condition, the click operation in the photo interface condition, and/or the sliding operation in the video playing interface condition. Only under the above scenarios, the mobile terminal performs corresponding functions. Otherwise, the mobile terminal maintains its current operation without any further responses. In this way, the mobile terminal could allow the user to use a single hand to control the mobile terminal to perform corresponding operations/functions without physical bottoms. This increases the integrity of the structure of the mobile terminal, raises the protection of the mobile terminal, makes it more convenient for the user to control, reduces the user's operation costs, and raises the user's operation efficiency.

The step S302 comprises the following steps: 1. Control the mobile terminal to adjust a volume of a ring when determining that the sliding operation is performed at the edge of the curved display of the mobile terminal in the main display condition. 2. Control the mobile terminal to take a photo when the click operation is performed at the edge of the curved display of the mobile terminal in the photo interface condition. 3. Control the mobile terminal to adjust a volume of a video when determining that the sliding operation is performed at the edge of the curved display of the mobile terminal in the video playing interface condition.

In addition, the step S302 could further comprise: Control the mobile terminal to perform the current operation/function when determining that the user's operation information is not the specific operation in the current interface condition.

For example, when the interface condition of the mobile terminal is the photo interface condition, if the user performs the sliding operation, then the mobile terminal does not respond to the sliding operation. This could prevent the mobile terminal from performing an incorrect operation and thus makes it easier for the user to use.

The control method further comprises following steps before step S100: 1. Determine whether a touch position is in the touch area at the edge of the curved display. 2. Determine whether the user's operation is in the touch area at the edge of the curved display. It not, then control the mobile terminal to perform other touch operations. If yes, then determine the user's operation information to control the mobile terminal to perform the corresponding function/operation.

Based on the above control methods, the present invention provides a machine readable storage medium. The readable storage medium stores one or more programs for a processor to execute to perform the above control methods of the mobile terminal.

A person having ordinary skills in the art could understand that all or a part of the control method could be completed by hardware executing the software program. The program could be stored in the computer/machine readable storage medium, such as ROMs, RAMs, hard disks and/or optical disks.

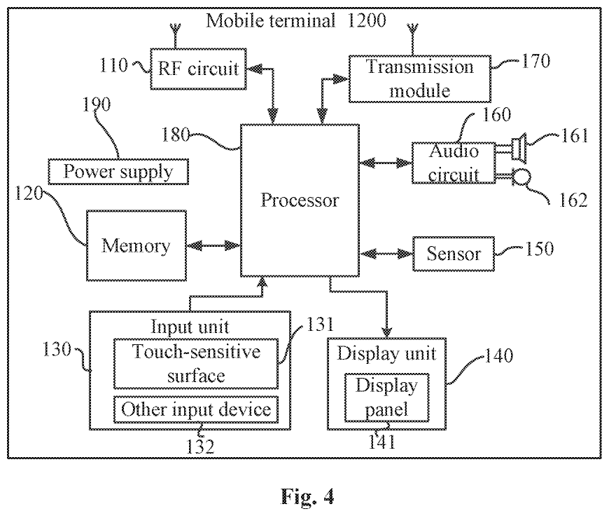

Based on the above control method, the present invention provides a mobile terminal. As shown in FIG. 3, the mobile terminal comprises a processor 10, a memory 20, and a bus. The bus is used for the processor 10 and the memory 20 to communicate with each other. That is, the processor 10 and the memory 20 to communicate with each other through the bus. The processor 10 is used to execute the control program 40 stored in the memory 20 to perform the following steps: obtaining a user's operation information in the touch area at the edge of the curved display of the mobile terminal; detecting an interface condition of the mobile terminal; and controlling the mobile terminal to perform a corresponding operation according to the interface condition and the user's operation information.

Similarly, in addition to the above steps, the processor 10 could execute the control program to perform more steps as previously mentioned. Since the steps are illustrated in the above, further illustration is omitted here.

The processor 10, the memory, and the bus are installed in the mobile terminal. The control program 40 is stored in the memory 20. The mobile terminal could be a cell phone, a tablet or other smart equipments. Please note, in this embodiment, only three components, the processor 10, the memory 20, and the display 30, are shown in FIG. 3 but this is not the limitation of the present invention. In the actual implementation, the mobile terminal could comprise less or more components. These changes all falls within the scope of the present invention.

FIG. 4 is a diagram of a detailed structure of a mobile terminal according to an embodiment of the present invention. The mobile terminal could be used to perform the above-mentioned control method. The mobile terminal 1200 could be a smart phone or a tablet.

As shown in FIG. 4, the mobile terminal 120 could comprise a RF circuit 110, a memory 120 having one or more computer readable storage devices (only one is shown), an input unit 130, a display unit 140, a sensor 150, an audio circuit 160, a transmission module 170, a processor 180 having one or more cores (only one is shown), and a power supply 190. A person having ordinary skills in the art could understand that the structure of the mobile terminal 1200 shown in FIG. 4 is not a limitation of the present invention. The mobile terminal 1200 could comprise less or more components and could have a different configuration or a different combination.

The RF circuit 110 may be configured to receive and send a signal during an information receiving and sending process or a conversation process. Specifically, after receiving downlink information from a base station, the RF circuit 110 delivers the downlink information to one or more processors 180 for processing, and sends related uplink data to the base station. Generally, the RF circuit 110 includes, but is not limited to, an antenna, at least one amplifier, a tuner, one or more oscillators, a subscriber identity module (SIM) card, a transceiver, a coupler, a low noise amplifier (LNA), and a duplexer. In addition, the RF circuit 110 may also communicate with a network and another device by wireless communication. The wireless communication may use any communications standard or protocol, which includes, but is not limited to, a Global System for Mobile communications (GSM), an Enhanced Data GSM Environment (EDGE),a Wideband Code Division Multiple Access (WCDMA), a Code Division Access (CDMA), a Time Division Multiple Access (TDMA), a Wireless Fidelity (Wi-Fi) such as IEEE 802.11a, IEEE 802.11b, IEEE802.11g and IEEE 802.11n, a Voice over Internet Protocol (VoIP), a Worldwide Interoperability for Microwave Access (Wi-Max), any other protocols for e-mail, instant communication and short message, and the like.

The memory 120 may be configured to store a software program and module. The processor 180 runs the software program and module stored in the memory 120, to implement various functional applications and data processing. The memory 120 may mainly include a program storage area and a data storage area. The program storage area may store an operating system, an application program required by at least one function (such as a sound playback function and an image display function), and the like. The data storage area may store data (such as audio data and an address book) created according to use of the terminal 1200, and the like. In addition, the memory 120 may include a high speed random access memory, and may also include a non-volatile memory, such as at least one magnetic disk storage device, a flash memory device, or another volatile solid-state storage device. Correspondingly, the memory 120 may further include a memory controller, so that the processor 180 and the input unit 130 access the memory 120.

The input unit 130 may be configured to receive input digit or character information, and generate keyboard, mouse, joystick, optical, or track ball signal input related to the user setting and function control. Specifically, the input unit 130 may include a touch-sensitive surface 131 and other input device 132. The touch-sensitive surface 131 may also be referred to as a touch screen or a touch panel, and may collect a touch operation of a user on or near the touch-sensitive surface (such as an operation of a user on or near the touch-sensitive surface 131 by using any suitable object or attachment, such as a finger or a stylus), and drive a corresponding connection apparatus according to a preset program. Optionally, the touch-sensitive surface 131 may include two parts: a touch detection apparatus and a touch controller. The touch detection apparatus detects a touch position of the user, detects a signal generated by the touch operation, and transfers the signal to the touch controller. The touch controller receives the touch information from the touch detection apparatus, converts the touch information into touch point coordinates, and sends the touch point coordinates to the processor 180. Moreover, the touch controller can receive and execute a command sent from the processor 180. In addition, the touch-sensitive surface 131 may be implemented by using various types, such as a resistive type, a capacitance type, an infrared type, and a surface sound wave type. In addition to the touch-sensitive surface 131, the input unit 130 may further include the another input device 132. Specifically, the another input device 132 may include, but is not limited to, one or more of a physical keyboard, a functional key (such as a volume control key or a switch key), a track ball, a mouse, and a joystick.

The display unit 140 may be configured to display information input by the user or information provided for the user, and various graphical user ports of the terminal 1200. The graphical user ports may be formed by a graph, a text, an icon, a video, and any combination thereof. The display unit 140 may include a display panel 141. Optionally, the display panel 141 may be configured by using a liquid crystal display (LCD), an organic light-emitting diode (OLED), or the like. Further, the touch-sensitive surface 131 may cover the display panel 141. After detecting a touch operation on or near the touch-sensitive surface 131, the touch-sensitive surface 131 transfers the touch operation to the processor 180, so as to determine a type of a touch event. Then, the processor 180 provides corresponding visual output on the display panel 141 according to the type of the touch event. Although, in FIG. 3, the touch-sensitive surface 131 and the display panel 141 are used as two separate parts to implement input and output functions, in some embodiments, the touch-sensitive surface 131 and the display panel 141 may be integrated to implement the input and output functions.

The terminal 1200 may further include at least one sensor 150, such as an optical sensor, a motion sensor, and other sensors. Specifically, the optical sensor may include an ambient light sensor and a proximity sensor. The ambient light sensor may adjust luminance of the display panel 141 according to brightness of the ambient light. The proximity sensor may switch off the display panel 141 and/or backlight when the terminal 1200 is moved to the ear. As one type of motion sensor, a gravity acceleration sensor may detect magnitude of accelerations at various directions (which generally are triaxial), may detect magnitude and a direction of the gravity when static, and may be configured to identify an application of a mobile phone attitude (such as switching between horizontal and vertical screens, a related game, and attitude calibration of a magnetometer), a related function of vibration identification (such as a pedometer and a knock). Other sensors, such as a gyroscope, a barometer, a hygrometer, a thermometer, and an infrared sensor, which may be configured in the terminal 1200 are not further described herein.

The audio circuit 160, a loudspeaker 161, and a microphone 162 may provide audio interfaces between the user and the terminal 1200. The audio circuit 160 may transmit, to the loudspeaker 161, a received electric signal converted from received audio data. The loudspeaker 161 converts the electric signal into a sound signal for output. On the other hand, the microphone 162 converts a collected sound signal into an electric signal. The audio circuit 160 receives the electric signal and converts the electric signal into audio data, and outputs the audio data to the processor 180 for processing. Then, the processor 180 sends the audio data to, for example, another terminal by using the RF circuit 110, or outputs the audio data to the memory 120 for further processing. The audio circuit 160 may further include an earplug jack, so as to provide communication between a peripheral earphone and the terminal 1200.

The terminal 1200 may help, by using the transmission module 170 (e.g. Wi-Fi module), a user to receive and send an e-mail, browse a webpage, and access stream media, and the like, which provides wireless broadband Internet access for the user. Although FIG. 3 shows the transmission module 170, it may be understood that, the wireless communications unit is not a necessary component of the terminal 1200, and can be ignored according to demands without changing the scope of the essence of the present disclosure.

The processor 180 is a control center of the terminal 1200, and connects various parts of the terminal by using various interfaces and lines. By running or executing the software program and/or module stored in the memory 120, and invoking data stored in the memory 120, the processor 180 performs various functions and data processing of the terminal 1200, thereby performing overall monitoring on the mobile phone. Optionally, the processor 180 may include one or more processing cores. Preferably, the processor 180 may integrate an application processor and a modem. The application processor mainly processes an operating system, a user interface, an application program, and the like. The modem mainly processes wireless communication. It may be understood that, the foregoing modem may not be integrated into the processor 180.

The terminal 1200 further includes the power supply 190 (such as a battery) for supplying power to the components. Preferably, the power supply may be logically connected to the processor 180 by using a power supply management system, thereby implementing functions, such as charging, discharging, and power consumption management, by using the power supply management system. The power supply 190 may further include any component, such as one or more direct current or alternate current power supplies, a re-charging system, a power supply fault detection circuit, a power supply converter or an inverter, and a power supply state indicator.

Although some components are not shown in FIG. 4, the mobile terminal 1200 could further comprise a camera (front camera and/or back camera) and a Bluetooth module. In addition, the display unit could be a touch display. The mobile terminal could further comprise a memory storing one or more programs. One or more of these programs are executed by the processor to perform the following operations:

determining whether a touch position is in a touch area at an edge of a curved display;

if the touch position is in the touch area at the edge of the curved display, obtaining a user's operation information in the touch area at the edge of the curved display of the mobile terminal;

detecting an interface condition of the mobile terminal;

controlling the mobile terminal to perform a corresponding operation according to the interface condition and the user's operation information; and

if the touch position is not in the touch area at the edge of the curved display, controlling the mobile terminal to perform a corresponding touch operation.

In the mobile terminal, the operation of controlling the mobile terminal to perform the corresponding operation according to the interface condition and the user's operation information comprises:

determining whether the user's operation information is a specific operation in a current interface condition; and

controlling the mobile terminal to perform a corresponding operation according to a predetermined function controlling rule if the user's operation is the specific operation in the current interface condition.

In the mobile terminal, the operation of controlling the mobile terminal to perform the corresponding operation according to the predetermined function controlling rule if the user's operation is the specific operation in the current interface condition comprises:

controlling the mobile terminal to adjust a volume of a ring when determining that a sliding operation is performed at the edge of the curved display of the mobile terminal in a main display condition.

In the mobile terminal, the operation of controlling the mobile terminal to perform the corresponding operation according to the predetermined function controlling rule if the user's operation is the specific operation in the current interface condition comprises:

controlling the mobile terminal to take a photo when a click operation is performed at the edge of the curved display of the mobile terminal in the photo interface condition.

In the mobile terminal, the operation of controlling the mobile terminal to perform the corresponding operation according to the predetermined function controlling rule if the user's operation is the specific operation in the current interface condition comprises:

controlling the mobile terminal to adjust a volume of a video when determining that a sliding operation is performed at the edge of the curved display of the mobile terminal in the video playing interface condition.

In the mobile terminal, after the operation of determining whether the user's operation information is the specific operation in the current interface condition, the one or more program instructions executable by the one or more processors to perform an operation of:

controlling the mobile terminal not to respond when determining that the user's operation information is not the specific operation in the current interface condition.

From the above, an embodiment of the present invention makes it more convenient for a user to use a single hand to perform a function of the mobile terminal. This reduces the user's operation costs and raises the user's operation efficiency. In addition, it also increases the integrity of the structure of the mobile terminal and thus increases the protections of the mobile terminal because the physical bottoms could be reduced.

Please note, one or more steps of the above-mentioned full visual navigation method could be achieved by instructing related hardware components (such as processor or controllers) through one or more programs. The above-mentioned programs could be stored in a computer readable storage medium such as a memory, a hard disk, an optical disk or etc.

Above are embodiments of the present invention, which does not limit the scope of the present invention. Any modifications, equivalent replacements or improvements within the spirit and principles of the embodiment described above should be covered by the protected scope of the invention.

What is claimed is:

1. A control method of a mobile terminal, the control method comprising:
obtaining a user's operation information in a touch area at an edge of a curved display of the mobile terminal;
detecting an interface condition of the mobile terminal; and
controlling the mobile terminal to perform a corresponding operation according to the interface condition and the user's operation information.

2. The control method of claim 1, wherein the user's operation information comprises a sliding operation and a click operation.

3. The control method of claim 2, wherein the interface condition comprises a main display condition, a photo interface condition and a video playing interface condition.

4. The control method of claim 3, wherein the step of controlling the mobile terminal to perform the corresponding operation according to the interface condition and the user's operation information comprises:
determining whether the user's operation information is a specific operation in a current interface condition; and
controlling the mobile terminal to perform a corresponding operation according to a predetermined function controlling rule if the user's operation is the specific operation in the current interface condition.

5. The control method of claim 4, wherein the specific operation in the current interface condition comprises a sliding operation in the main display condition, a click operation in the photo interface condition, and/or a sliding operation in the video playing interface condition.

6. The control method of claim 5, wherein the step of controlling the mobile terminal to perform the corresponding operation according to the predetermined function controlling rule if the user's operation is the specific operation in the current interface condition comprises:
controlling the mobile terminal to adjust a volume of a ring when determining that the sliding operation is performed at the edge of the curved display of the mobile terminal in the main display condition;
controlling the mobile terminal to take a photo when the click operation is performed at the edge of the curved display of the mobile terminal in the photo interface condition; and
controlling the mobile terminal to adjust a volume of a video when determining that the sliding operation is performed at the edge of the curved display of the mobile terminal in the video playing interface condition.

7. The control method of claim 4, further comprising following steps after the step of determining whether the user's operation information is the specific operation in the current interface condition:
controlling the mobile terminal not to respond when determining that the user's operation information is not the specific operation in the current interface condition.

8. The control method of claim 1, further comprising following steps before the step of obtaining the user's operation information in the touch area at the edge of the curved display of the mobile terminal:
determining whether a touch position is in the touch area at the edge of the curved display; and
if the touch position is in the touch area at the edge of the curved display, then performing the step of obtaining the user's operation information in the touch area at the edge of the curved display of the mobile terminal.

9. A mobile terminal, comprising:
a touch chip;
a storage device, configured to store a control program of the mobile terminal;
a processor; and
a bus, configured to realize communications between the processor and the storage device;
wherein the processor is configured to execute the control program to perform following operations:
determining whether a touch position is in a touch area at an edge of a curved display;
if the touch position is in the touch area at the edge of the curved display, obtaining a user's operation information in the touch area at the edge of the curved display of the mobile terminal;
detecting an interface condition of the mobile terminal;
controlling the mobile terminal to perform a corresponding operation according to the interface condition and the user's operation information; and
if the touch position is not in the touch area at the edge of the curved display, controlling the mobile terminal to perform a corresponding touch operation.

10. The mobile terminal of claim 9, wherein the operation of controlling the mobile terminal to perform the corresponding operation according to the interface condition and the user's operation information comprises:
determining whether the user's operation information is a specific operation in a current interface condition; and
controlling the mobile terminal to perform a corresponding operation according to a predetermined function controlling rule if the user's operation is the specific operation in the current interface condition.

11. The mobile terminal of claim 10, wherein the operation of controlling the mobile terminal to perform the corresponding operation according to the predetermined function controlling rule if the user's operation is the specific operation in the current interface condition comprises:
controlling the mobile terminal to adjust a volume of a ring when determining that a sliding operation is performed at the edge of the curved display of the mobile terminal in a main display condition.

12. The mobile terminal of claim 10, wherein the operation of controlling the mobile terminal to perform the corresponding operation according to the predetermined function controlling rule if the user's operation is the specific operation in the current interface condition comprises:
controlling the mobile terminal to take a photo when a click operation is performed at the edge of the curved display of the mobile terminal in the photo interface condition.

13. The mobile terminal of claim 10, wherein the operation of controlling the mobile terminal to perform the corresponding operation according to the predetermined function controlling rule if the user's operation is the specific operation in the current interface condition comprises:
controlling the mobile terminal to adjust a volume of a video when determining that a sliding operation is performed at the edge of the curved display of the mobile terminal in the video playing interface condition.

14. The mobile terminal of claim 10, wherein the processor executes the control program to further perform a following operation before the operation of determining whether the user's operation information is the specific operation in the current interface condition:
controlling the mobile terminal not to respond when determining that the user's operation information is not the specific operation in the current interface condition.

15. A machine readable storage medium, storing one or more program instructions executable by one or more processors to perform operations of:
determining whether a touch position is in a touch area at an edge of a curved display;
if the touch position is in the touch area at the edge of the curved display, obtaining a user's operation information in the touch area at the edge of the curved display of the mobile terminal;
detecting an interface condition of the mobile terminal;
controlling the mobile terminal to perform a corresponding operation according to the interface condition and the user's operation information; and
if the touch position is not in the touch area at the edge of the curved display, controlling the mobile terminal to perform a corresponding touch operation.

16. The machine readable storage medium of claim 15, wherein the operation of controlling the mobile terminal to perform the corresponding operation according to the interface condition and the user's operation information comprises:
determining whether the user's operation information is a specific operation in a current interface condition; and
controlling the mobile terminal to perform a corresponding operation according to a predetermined function controlling rule if the user's operation is the specific operation in the current interface condition.

17. The machine readable storage medium of claim 16, wherein the operation of controlling the mobile terminal to perform the corresponding operation according to the predetermined function controlling rule if the user's operation is the specific operation in the current interface condition comprises:
controlling the mobile terminal to adjust a volume of a ring when determining that a sliding operation is performed at the edge of the curved display of the mobile terminal in a main display condition.

18. The machine readable storage medium of claim 16, wherein the operation of controlling the mobile terminal to perform the corresponding operation according to the predetermined function controlling rule if the user's operation is the specific operation in the current interface condition comprises:
controlling the mobile terminal to take a photo when a click operation is performed at the edge of the curved display of the mobile terminal in the photo interface condition.

19. The machine readable storage medium of claim 16, wherein the operation of controlling the mobile terminal to perform the corresponding operation according to the predetermined function controlling rule if the user's operation is the specific operation in the current interface condition comprises:
controlling the mobile terminal to adjust a volume of a video when determining that a sliding operation is performed at the edge of the curved display of the mobile terminal in the video playing interface condition.

20. The machine readable storage medium of claim 16, wherein after the operation of determining whether the user's operation information is the specific operation in the current interface condition, the one or more program instructions executable by the one or more processors to perform an operation of:
controlling the mobile terminal not to respond when determining that the user's operation information is not the specific operation in the current interface condition.
